(19) United States
(12) Patent Application Publication
(10) Pub. No.: US 2026/0183746 A1
(43) Pub. Date: Jul. 2, 2026

(54) SURFACE MODIFIED BIOPOLYMERS FOR REMOVAL OF PER- AND POLYFLUOROALKYL SUBSTANCES FROM LIQUID

(71) Applicant: The Research Foundation for the State University of New York, Albany, NY (US)

(72) Inventors: Yanna Liang, Albany, NY (US); Aswin ILango, Albany, NY (US)

(21) Appl. No.: 19/220,799

(22) Filed: May 28, 2025

Related U.S. Application Data
(60) Provisional application No. 63/652,361, filed on May 28, 2024.

(51) Int. Cl. B01J 20/26; B01J 20/28; B01J 20/30; C02F 1/28; C02F 101/36

(52) U.S. Cl. CPC B01J 20/267; B01J 20/28023; B01J 20/28047; B01J 20/3007; B01J 20/3085; C02F 1/288; C02F 1/285; C02F 1/286; C02F 2101/36

(57) ABSTRACT

A biosorbent that removes per- and polyfluoroalkyl substances (PFAS) from a liquid, such as water, and method of use thereof. The biosorbent includes a biopolymer, such as a natural polysaccharide, mixed with polyethyleneimine and cross-linked to form at least a semisolid at a concentration sufficient to substantially remove PFAS upon the semisolid being mixed in a PFAS-containing liquid and then being removed therefrom.

### CROSS-REFERENCE TO RELATED APPLICATION

This invention claims the benefit of U.S. Provisional Patent Application No. 63/652,361, filed May 28, 2024, the entirety of which is hereby incorporated herein by this reference.

### STATEMENT REGARDING FEDERALLY SPONSORED RESEARCH

This invention was made with government support under grant number CBET2225596, awarded by the National Science Foundation. The government has certain rights in the invention.

### BACKGROUND OF THE INVENTION

### 1. Field of the Invention

The present invention generally relates to decontamination of polluted liquids by removal of contaminants. More particularly, the present invention relates to a system and method for decontaminating water that is polluted with per- and polyfluoroalkyl substances (PFAS).

### 2. Description of the Related Art

Per- and polyfluoroalkyl substances (PFAS) have been recognized as the contaminants of emerging concern and listed in the top group of unregulated contaminants by the U.S. EPA due to their toxicity and bioaccumulation. Although most public and regulatory attentions have so far focused on anionic PFAS with polar (carboxylate (COO⁻) or sulfonate (SO₃⁻)) head groups, zwitterionic and cationic PFAS have been detected in numerous environmental matrices. Due to the widespread use and environmental persistence, PFAS have entered surface water, groundwater, soil and sediment that may very possibly impact human health and the ecosystem.

The U.S. EPA and Centers for Disease Control and Prevention (CDC) have reported that exposure to high levels of PFAS may lead to adverse health effects, such as developmental effects in children, decreased immunity and fertility in women and cancers. The EPA in June 2022 published the interim lifetime health advisory levels of perfluorooctanoic acid (PFOA) and perfluorooctanesulfonic acid (PFOS) in drinking water as 0.004 ng/L and 0.02 ng/L, respectively. These extremely low levels and stable C—F bonds in their structures pose a serious challenge to remediation and demand innovative and sustainable technologies to remove PFAS in water to such low concentrations.

During the past several decades, a wide range of techniques, for instance advanced oxidation and photocatalytic reduction have been investigated for removing PFAS from water. However, these technologies have limitations like high energy consumption and harsh reaction conditions that restrain their potential for large-scale applications. Phytoremediation, which is a green and sustainable approach, is challenged by its slow uptake of PFAS by plants. On the other hand, PFAS removal by adsorption is an established technology. Adsorption can be used as a single process for point-of-use applications and as a unit operation in the process of treating water at municipal scale.

Numerous adsorbents have been reported in the literature for PFAS removal. Among them, a few are commercially available, such as granular activated carbon (GAC), powdered activated carbon (PAC), natural clays, and resins. At pilot scales, GAC showed a higher capacity to remove long chain PFAS compared to biochar and anthracite. However, both bench and pilot scale experiments revealed the ineffectiveness and slow kinetics of both biochar and GAC to remove short chain PFAS. The frequent reactivation or change-out process for both GAC and biochar is a concern in their large-scale applications for treatment of real water containing natural organic matter (NOM). The NOM can lead to growth of biofilm on the sorbent's surface over limited periods of operation. The resins, on the other hand, can bind with non-PFAS molecules in real water, which reduces their sorption towards PFAS and creates a need for more frequent regeneration to meet the desired criteria for PFAS removal.

Modified clay or organoclay, has been reported to possess much higher sorption capacity and faster kinetics than those of GAC given their fine powder form with large specific surface area for sorption. These powders, once in water, may form stable colloids which are difficult to remove from water. The powder particles themselves also necessitate centrifugation or filtration for separation. These drawbacks thus hinder their application in real-world, commercial drinking water treatment.

PFAS removal using sorbents, and especially environmentally friendly sorbents, under different environmental conditions are needed. A better PFAS sorbent with a sorption mechanism is vital, such as a green, renewable, and sustainable material, for removing PFASs in water. It accordingly is to the production and use of such materials and methods for the removal of PFAS from water that the present invention is primarily directed.

### BRIEF SUMMARY OF THE INVENTION

Briefly described, the present system and method modify the surface of biopolymers to remove PFAS from liquids, and in particular, water. These biopolymers can be fabricated into desirable shapes, such as aerogels, fibers, membranes, and beads. These shapes and forms enable the biosorbents to be easily separated from PFAS treated water without using centrifugation or filtration that is required for commercial sorbents (i.e., PAC, clay) and other fine powder materials. The present biosorbents are amine-modified natural materials used to remove PFAS at scale.

This invention addresses the need for innovative, green and low-cost sorbents for removing PFAS from drinking water. Currently, granular activated carbon (GAC) has been the default material for PFAS removal. But given its high cost, inefficiency and slow kinetics for removing short-chain PFAS, new materials are urgently needed to meet the regulatory requirement with regard to PFAS removal. The biosorbents disclosed here are simple to fabricate, have high sorption capacity, can be regenerated and reused and have demonstrated nearly 100% removal of all target PFAS. Thus, these materials have great potential to replace GAC and be used for removing PFAS in drinking water, surface water and groundwater.

The invention provides, in one aspect, a biosorbent that includes a biopolymer made of, at least, a polysaccharide; and polyethyleneimine, wherein the biopolymer and polyethyleneimine are cross-linked and formed into at least a semisolid at a concentration sufficient to substantially remove PFAS upon the semisolid being mixed in a PFAS-containing liquid. The biopolymer can be made of one or more natural polysaccharides, such as an alginate or a chitosan. Furthermore, the semisolid can be comprised of fibers or an aerogel. The biosorbent can also include a cross-linker, such as one of glutaraldehyde (GTH), epichlorohydrin (ECH) or both.

In another aspect, the invention provides a method of making a biosorbent by mixing a biopolymer having, at least, a polysaccharide with polyethyleneimine such that the biopolymer and polyethyleneimine are cross-linked in a mixture, and then forming the mixture into, at least, a semisolid at a concentration sufficient to substantially remove PFAS upon the semisolid being mixed in a PFAS-containing liquid.

In a further embodiment, the invention includes a method of removing PFAS from a liquid with a biosorbent by adding a semisolid biosorbent to a PFAS-containing liquid at a concentration sufficient to substantially remove PFAS from the PFAS-containing liquid, with the semisolid biosorbent comprised of biopolymer linked with polyethyleneimine. Then the method continues by removing the semisolid biosorbent from the PFAS-containing liquid after a predetermined duration.

The present invention provides an advantage in removing PFAS contaminated water in an environmentally friendly, renewable, and effective manner. The present invention is further industrial applicable in the commercial treatment of PFAS contaminated water, such as drinking water, ground water, and waste runoff. Other objects features and advantages of the present invention will be apparent to one of skill in the art after review of the present application.

### BRIEF DESCRIPTION OF THE DRAWINGS

FIG. 1 is a representative diagram of mixing PFAS contaminated water an aerogel biosorbent to remove a substantial amount the PFAS.

FIG. 2 is a series of graphs of the removal efficacy of several biosorbents.

FIG. 3A is graph of FTIR spectra of ALGPEI-1, ALGPEI-2, ALGPEI-3 and PFASs containing ALGPEI-3.

FIG. 3B is a graph of FTIR spectra GTH-CTNPEI and PFASs containing GTH-CTNPEI aerogels.

FIG. 4 is a series of graphs of the removal efficacy of several biosorbents.

FIG. 5 is a graph of sorption capacity changing with initial PFOA concentration and time.

FIG. 6A is a graph of removal efficiency of representative PFOA after three cycles of regeneration and reuse.

FIG. 6B is a graph of removal efficiency of representative PFOS after three cycles of regeneration and reuse.

FIG. 6C is a graph of removal efficiency of representative PFNA after three cycles of regeneration and reuse.

### DETAILED DESCRIPTION OF THE INVENTION

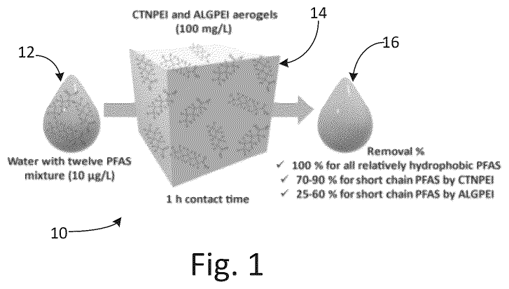

With reference to the figures in which like numerals represent like elements throughout the several views, FIG. 1 shows a system 10 for removing PFAS from a liquid, such as water. There is a biosorbent 14 that includes a biopolymer made of, at least, a polysaccharide; and polyethyleneimine, wherein the biopolymer and polyethyleneimine are cross-linked and formed into at least a semisolid at a concentration sufficient to substantially remove PFAS upon the semisolid being mixed in a PFAS-containing liquid 12. Here the biopolymer can be CTNPEI and ALGPEI as is more fully describe here, with one or more natural polysaccharides, such as an alginate or a chitosan. Furthermore, the semisolid can be comprised of fibers or an aerogel. The biosorbent can also include a cross-linker, such as one of glutaraldehyde (GTH), epichlorohydrin (ECH) or both.

In another aspect, as shown in FIG. 1, the present invention provides a method of removing PFAS from a liquid with a biosorbent by adding a semisolid biosorbent 16 to a PFAS-containing liquid 12 at a concentration sufficient to substantially remove PFAS from the PFAS-containing liquid 12, with the semisolid biosorbent 14 comprised of biopolymer linked with polyethyleneimine. Then the method continues by removing the semisolid biosorbent 14 from the PFAS-containing liquid 16 after a predetermined duration, to leave substantially less PFAS-contaminated water 16. Here, one example of the predetermined duration is 1 hour of contact time.

In overview, this invention is about biopolymer-based sorbents designed for removing per- and polyfluoroalkyl substances (PFAS) from water contaminated by these emerging compounds. The inventors conducted extensive testing of 11 biosorbents determined that two sorbents, alginate (ALG) and chitosan (CTN) based and polyethyleneimine (PEI) functionalized fibers/aerogels had the best sorption performance toward adsorption of mixtures of 12 PFAS (9 short- and long-chain PFAAs, GenX, and 2 precursors) from water at an initial concentration of 10 μg/L each. Both aerogels had fast and superior sorption of relatively hydrophobic PFASs from pH 2 to 10. Even at extreme pH conditions, the aerogels retained their shape perfectly. Based upon sorption isotherms, the maximum adsorption capacity of ALGPEI and GTH-CTNPEI aerogels towards total PFAS removal. was 3045 and 12133 mg/g, respectively. Compared to sorption capacity of hundreds of mg/g for most PFAS sorbents, these sorption capacities are exceptional.

ALG- and CTN-based biosorbents were determined to have high sorption capacity toward mixtures of 12 PFASs and possess fast sorption kinetics, excellent shape recovery, and structural stability. The biosorbents allow for practical use for removing PFASs in a wide range of water matrices, for instance drinking water, storm water, effluent from wastewater treatment plants, and landfill leachate.

Considering the different drawbacks associated with conventional and new sorbents, green, renewable, and sustainable biomaterials are needed for removing PFAS in water. Among various biopolymers, chitosan (CTN) is a natural amino-polysaccharide consisting D-glucosamine and N-acetyl-D-glucosamine residues attained from deacetylation of chitin. Alginate (ALG), extensively abundant in brown algae, is a linear copolymer with mannuronic acid (M) and guluronic acid (G) residues. Cellulose (CEL) formed from the condensation of D-glucose units through β(1→4) glycosidic bonds is widely present in almost all plant materials.

Sorbents are insoluble materials or mixtures of materials used to recover liquids through the mechanism of absorption, or adsorption, or both. Absorbents are materials that pick up and retain liquid distributed throughout its molecular structure, often causing the solid to swell. Consequently, the biosorbent 14 here can use the mechanism of absorption, adsorption of both. Additionally, as further described herein, the biopolymers can be fabricated into desirable shapes, such as aerogels, fibers, membranes, and beads.

In this study, Milli-Q water (resistivity ≥18.0 MΩ-cm) was used to prepare PFASs solutions. ALGPEI based aerogel was prepared by 0.1 g of Na-ALG being dissolved in a mixed solution of 4.90 mL of deionized water and 0.14 mL of glutaraldehyde (GTH) (5 wt. %) in a 100 mL polypropylene beaker. The solution was then stirred for 45 min to achieve a transparent ALG solution without any air bubbles. To this ALG solution, a PEI solution [0.24 mL of PEI (50% in water)+4.90 mL of deionized water] was added dropwise for 30 min with vigorous stirring for a total of 3 h at 25° C. to reach a uniform pink emulsion. Finally, the obtained ALGPEI emulsion was incubated at 60° C. for 1 h to achieve ALGPEI gelation. The gel was then frozen at −20° C. for 24 h followed by freeze-drying at −45° C. for 24 h. The resulting ALGPEI aerogel is referred to as ALGPEI-1 throughout the rest of this paper. ALGPEI-2 and ALGPEI-3 were likewise prepared through using PEI at 0.48 and 0.97 mL, respectively. In addition, ALGPEI based fibers and cetyltrimethylammonium chloride (CTAC) surfactant modified ALGPEI (CTAC-ALGPEI) aerogels.

The procedure for ALGPEI aerogel was also applied for the synthesis of CTNPEI based aerogel. In this case, 0.1 g of CTN was dissolved in the mixed solutions of 2% acetic acid (v/v) and GTH (5 wt. %) in a 100 mL polypropylene beaker. The solution was then stirred for 30 min, after which time a PEI solution was added dropwise for 30 min, followed by additional stirring at 25° C. for 3 h. This produced a uniform brownish-orange emulsion. After incubating the emulsion at 60° C. for 1 h, the obtained gel was then frozen at −20° C. for 24 h followed by freeze drying at −45° C. for 24 h to obtain GTH-CTNPEI aerogel. Similarly, epichlorohydrin (ECH) cross-linked CTNPEI (ECH-CTNPEI) aerogels were prepared. After preparation, all biosorbents were stored in tightly sealed containers at 25° C. for further use.

The screening of biopolymers-based fibers and aerogels for adsorption of PFASs in aqueous mixtures, and the removal efficiencies of the prepared fibers were found to be less than 70% for all target PFASs. Short chain PFASs removal by these fibers was even less effective despite increasing PEI to 50 wt. %. The beneficial effect of PEI was only detected for four PFASs: PFDA, PFUnA, PFOS, and N-EtFOSAA. The exact PEI content leading to enhancement of PFASs sorption, however, differed among these four. For PFUnA, the highest removal was observed for those with PEI at 13 wt. %. In the case of PFOS, a gradual increase of removal from ALG to ALGPEI-C was noticed, but the overall removal % of total PFASs by all ALGPEI fibers was found to be <30%.

Theoretically speaking, higher PEI content can provide more reactive —NH₂ functional groups on the ALG surface, which should improve PFASs binding. But our study here showed that PEI's role in PFASs adsorption was insufficient, especially for PFCAs, PFBS, PFHxS, GenX and 6:2 FTSA. For the four PFASs where enhancement of sorption by PEI was observed, the dose response effects were different.

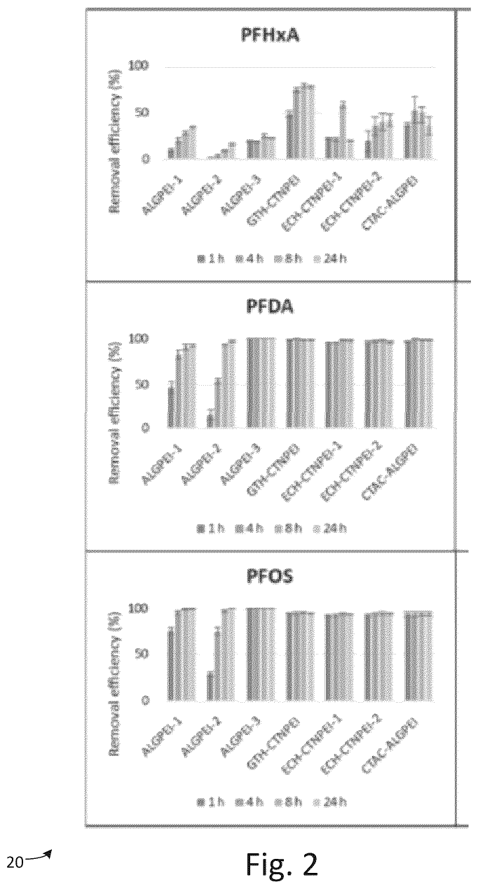

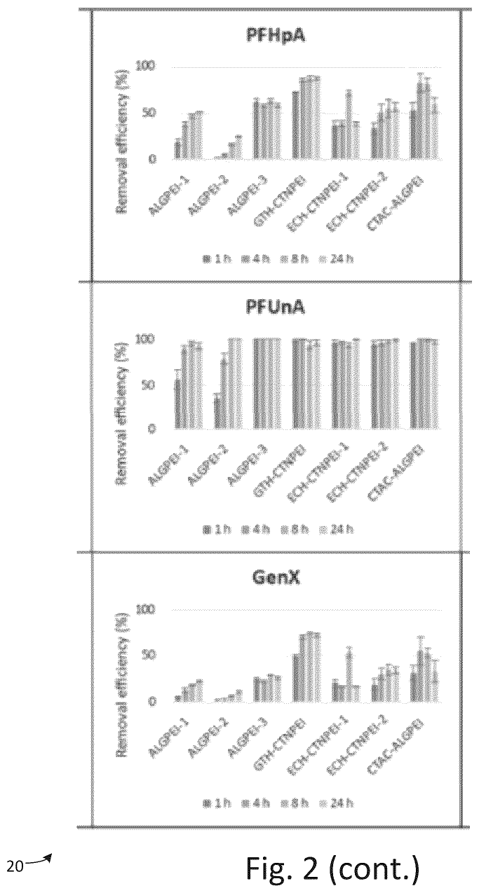

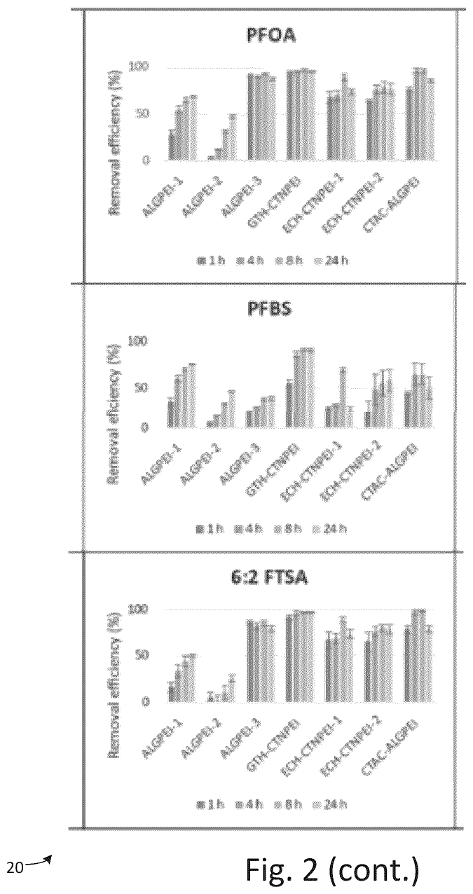

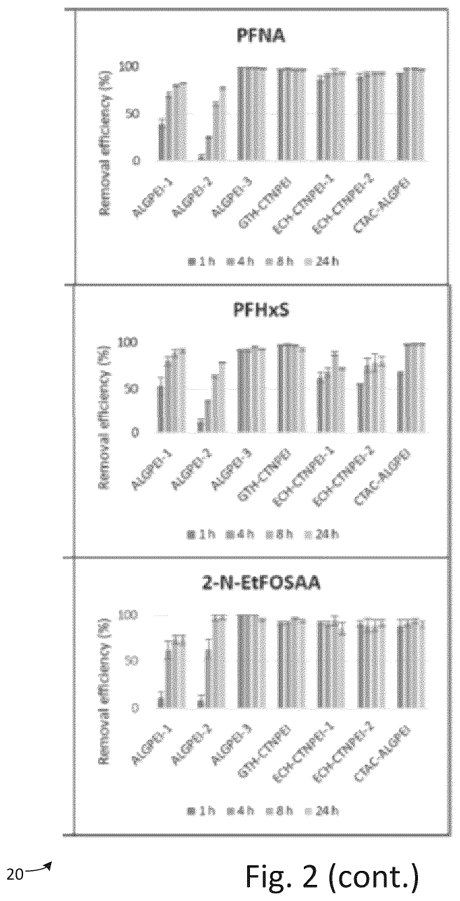

To identify the equilibrium time for PFASs adsorption for these aerogels, subsamples were collected at 1, 4, 8 and 24 h as shown in FIG. 2. It was observed that: (1) the ALGPEI aerogels had higher removal of all PFASs compared to ALGPEI fibers (FIG. 2); (2) for ALGPEI-1 and ALGPEI-2, PFASs removal increased with time from 1 to 24 h. This is true for all target PFASs; (3) regarding ALGPEI-3, the time effect was not significant. Within one hour, this sorbent removed 100% of PFNA, PFDA, PFUnA, PFOS and 2-N-EtFOSAA and was the best among all tested sorbents for removing these five PFASs. Its removals of PFOA, PFHxS and 6:2 FTSA were close to those of GTH-CTNPEI. In terms of short chain PFASs, such as PFHxA, PFHpA, GenX, and PFBS, ALGPEI-3 was inferior to GTH-CTNPEI. Compared to ALGPEI-1 and ALGPEI-2, the structural stability of the ALGPEI-3 aerogels was significantly higher as a result of increasing the PEI dose from 28.57 to 90.91 wt. %; (4) Among all sorbents assessed, GTH-CTNPEI had the best performance for removing PFHxA, PFHpA, PFOA, PFHxS, PFBS, 6:2 FTSA and GenX. Its sorption of long chain PFASs was similar to those of ALGPEI-3; and (5) the other sorbents, ECH-CTNPEI-1, ECH-CTNPEI-2, and CTAC-ALGPEI had similar sorption performance for the long chain PFASs as those of ALGPEI-3, but their captures of short chain PFASs were less than satisfactory compared to GTH-CTNPEI.

Here, ECH and GTH were used as cross-linkers to enhance the binding nature of PEI with biopolymers. It was observed that the ECH-assisted CTNPEI aerogels had weaker structural stability than the GTH-CTNPEI aerogels. Additionally, ECH cross-linker is often considered carcinogenic in nature while GTH is not as toxic as ECH. Given the much better performance of GTH-CTNPEI for removing all PFASs, this sorbent was studied further. Surfactants have been used to modify clay and led to organoclays for removing PFASs. Detailed studies have been reported for Fluorosorb and matCARE. Recently, it has been reported that CTAC-modified clays had far superior performance for removing both long and short chain PFASs in water compared to conventional sorbents, such as GAC. Thus, the present inventive study determined whether CTAC-modified ALGPEI could remove PFASs more effectively than the unmodified material. As predicted, the CTAC-ALGPEI aerogel exhibited higher adsorption than ALGPEI-3 for short chain PFASs, PFOA, GenX and 6:2 FTSA. Its adsorption of PFUnA, PFOS and 2-N-EtFOSAA, however, was less than that of ALGPEI-3. Additionally, the structural stability of ALGPEI-3 weakened due to the inclusion of CTAC into the aerogel network.

FIG. 2 is a series of graphs 20 of the removal efficacy of several biosorbents. Specifically shown are the adsorption of PFASs by ALGPEI-1, ALGPEI-2, ALGPEI-3, GTH-CTNPEI, ECH-CTNPEI-1, ECH-CTNPEI-2 and CTAC-ALGPEI aerogels at 1, 4, 8 and 24 h. Initial PFASs concentration: 10 μg/L, and aerogel's dose: 100 mg/L. Error bars represent the standard deviations of triplicate measurements. Some error bars are not visible due to their small sizes.

From all screening tests conducted, ALGPEI-3 and GTH-CTNPEI aerogels were identified as the best for PFASs adsorption. Both aerogels were able to remove almost 100% of relatively hydrophobic PFCAs (C9-C11), PFOS, and 2-N-EtFOSAA in 1 hour. GTH207 CTNPEI was also able to remove 70-90% of the other relatively hydrophilic PFASs. To understand the time effect better, we assessed PFASs removal by these two aerogels at shorter time intervals, such as 15, 30, 45 and 60 min. It was revealed that: 1) adsorption of all target PFASs with ALGPEI-3 was spontaneous under the tested conditions. Adsorption of 100% PFCAs (C9-C11), PFOS, and 2-N210 EtFOSAA was achieved in 15 min; and 2) similarly, GTH-CTNPEI aerogels exhibited immediate adsorption of these five PFASs. Its adsorption of short chain PFASs, such as PFHxA, PFHpA, PFBS, and GenX, however, did increase slightly as the contact time rose from 15 to 60 min. To better understand the sorption performance/mechanisms, the effect of pH, sorption isotherms, and sorbent structures were further investigated for these two types of aerogels.

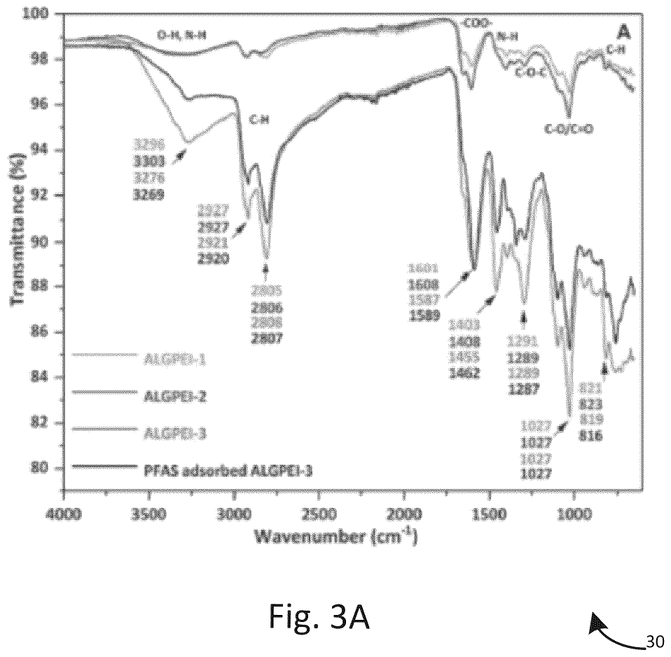

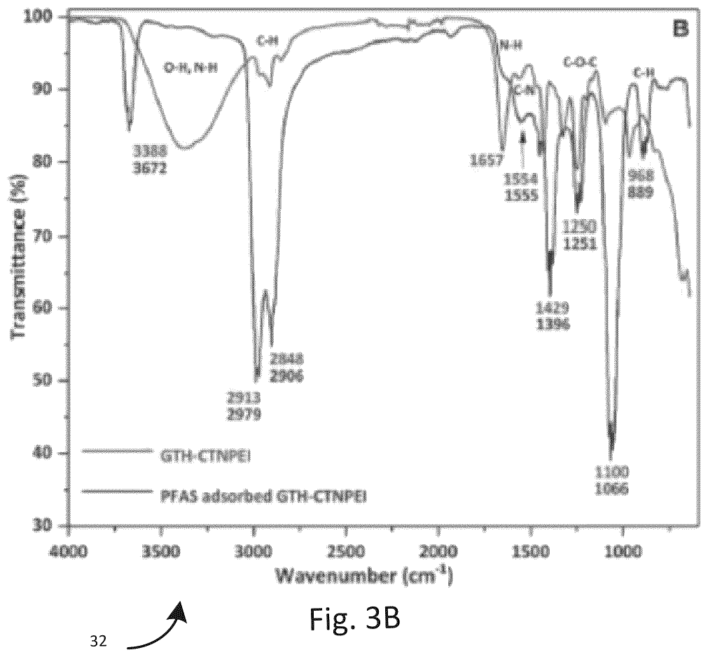

FTIR was performed to verify the composition, i.e., the functional groups, in the prepared aerogels and to confirm the adsorption mechanism involved in PFASs removal. FIG. 3A is graph of FTIR spectra of ALGPEI-1, ALGPEI-2, ALGPEI-3 and PFASs containing ALGPEI-3. FIG. 3B is a graph of FTIR spectra GTH-CTNPEI and PFASs containing GTH-CTNPEI aerogels.

In FIG. 3A, graph 30 shows the FTIR spectra of all three ALGPEI aerogels, the stretching vibration of the O—H group of ALG appeared as a broad band in the range of 3303-3269 cm⁻¹. The asymmetric and symmetric vibrations of the —COO— from carbonyl and carboxyl groups of ALG were detected in the range of 1601-1589 and 1462-1403 cm⁻¹, respectively. The C—O—C and C—O/C═O stretching vibrations in the carboxyl component of ALG appeared in the range of 1291-1287 and 1025 cm⁻¹, respectively. In the FTIR spectra of the ALGPEI-3 aerogel, a band at 3276 cm⁻¹ showed up as one that could be attributed to the N—H stretching vibrations of PEI (with higher dose) in addition to the O—H stretching vibration of ALG.

The antisymmetric stretching and bending vibrations of C—H in —CH₂/—CH₃ groups of PEI was observed around 2927-2920/2807-2805 and 821-816 cm⁻¹, correspondingly. Essentially, the signal at 1455 cm⁻¹ was related to the stretching vibrations of N—H from PEI, whose intensity rose with increasing dose of PEI as seen in the FTIR spectra of ALGPEI-1 to ALGPEI-3, further showing that the NH₂ group of PEI was successfully grafted onto ALG.

In the FTIR spectra of the GTH-CTNPEI aerogel (FIG. 3B, graph 32), the wide stretching vibrations of N—H and O—H groups of CTN was observed at around 3388 cm⁻¹. The characteristic amide I vibration, bending vibration of C—H, and stretching vibration of C—O—C were detected at around 1657, 1429, and 1100 cm⁻¹, respectively. The antisymmetric stretching and bending vibrations of C—H in the —CH₂/—CH₃ groups of PEI were observed at 2913/2848 and 968 cm⁻¹, respectively. The adsorption band at 1554 cm⁻¹ was associated with the C—N asymmetric stretching vibration, which was generated by the attractive interaction between the NH₂ groups from PEI and CTN, indicating that these polymers were linked through GTH. It was observed that most of the FTIR bands of ALGPEI-3 and GTH-CTNPEI aerogels reappeared in the FTIR spectra of those containing PFASs. Some of the bands in the original sorbents disappeared, indicating the interactions between PFASs and the aerogel's surface.

Results from the FTIR studies hinted that the PFASs adsorption mechanisms were: (i) Electrostatic interactions by —OH and —NH₂ functional groups: in the ALGPEI-3 aerogel, the broad stretching vibrations of N—H and O—H at 3269 cm⁻¹ were reduced in intensity after PFASs adsorption, whereas for the GTH-CTNPEI aerogel, the same stretching vibrations were shifted to a higher wavenumber of 3672 cm⁻¹. This demonstrated that the electrostatic interactions did occur between the protonated functional groups (O—H and N—H) of the aerogels and anionic PFASs. (ii) Hydrophobic interactions: in the GTH-CTNPEI aerogel, the higher stretching and bending vibrations of C—H in —CH₂/—CH₃ groups of the PEI were observed at 2979 and 2906 cm⁻¹, respectively, after PFASs adsorption, which confirmed the dominant hydrophobic interactions between the C—H groups of PEI and C—F of PFASs. In the case of ALGPEI, the C—H bands of the PEI were also observed at 2920/2807 cm⁻¹, but were not strong compared with that in the FTIR spectra of PFASs containing GTH-CTNPEI aerogel.

There were no specific FTIR bands detected as a result of PFASs adsorption. The typical FTIR band for PFOS is around 1200-1350 cm⁻¹, which corresponds to the vibrations of —CF₃ and —CF₂⁻ groups and could be used as an indicator of organic fluorine. The other bands shown in 1150-1250 cm⁻¹ and 1000-1075 cm⁻¹ could be assigned to the vibrations of organic sulfonate (SO₃⁻) group. Hence, the strong FTIR signals listed above after adsorption confirmed that PFASs molecules were strongly connected with the aerogels' surface via electrostatic and hydrophobic interactions. The interactions between PFASs and the GTH-CTNPEI aerogel were stronger than those of the ALGPEI-3 aerogel, which explains overall higher removal efficiencies of GTH-CTNPEI towards PFASs than the ALGPEI-3 aerogel.

Scanning electron microscopy (SEM) was used to investigate the surface morphology of the ALGPEI-3 and GTH-CTNPEI aerogels. With respect to the ALGPEI-3 aerogel, the surface coating and cross-linking of 1.0 g PEI to ALG provided an uneven open honeycomb-like structure. For the GTH-CTNPEI aerogel, with the PEI dose of 80 wt. % to CTN of 8 wt. % cross-linked using GTH of 12 wt. %, the aerogel started to assemble into a more homogeneous and denser network, which possessed an ideal interconnected framework. It is noteworthy that there was no microporous structure of the aerogels due to the high dose of PEI (i.e., 1:10 ratio of the biopolymer and PEI). In this case, the PEI completely covered the biopolymer's surface, leading to the decrease of the porous properties of the aerogels. The elemental composition in the EDS spectra indicated that the significant elements of ALGPEI-3 and GTH-CTNPEI aerogels included C, N and O.

The insignificant Na element with 0.12 wt. % was from the sodium alginate biopolymer. For analysis of pore size distribution (PSD), both aerogels were activated under the same reduced pressure (50 mTorr) condition at 25° C. for 24 hours. During PSD analysis, both aerogels showed extremely low absorbances, and their isotherms were hard to interpret since they were close to 0. As a result, both aerogels possessed low BET surface area and PSD. PEI at the high dose appeared to play a key role in reducing the porous surface of the aerogels. From SEM and PSD analysis, it was concluded that the synthesized aerogels were not porous in nature and their structural stabilities were found to be stronger with increasing dose of PEI. Therefore, the adsorption performances of the aerogels were mainly due to the amine functionalization and the —CH₂⁻ segments of the PEI onto the biopolymers, but not the surface area and porous nature of the aerogels.

To assess the thermal stabilities of the ALGPEI-3 and GTH-CTNPEI aerogels, TGA was performed in the range of room temperature −700° C. The weight losses of the aerogels were divided into three stages. The first stage below 125° C. with 14.63% weight loss for ALGPEI-3 and 34.13% weight loss for the GTH-CTNPEI aerogel was due to the evaporation of water molecules (i.e., bound water and physically absorbed water) and organic solvents (GTH) on the surface of the GTH-CTNPEI aerogel. During the second stage at 125-223° C., the weight loss of ALGPEI-3 was 6.24%. At 101-210° C., the weight decrease of the GTH-CTNPEI aerogel was 17.30%. These weight reductions might be attributed to the decomposition of unstable oxygen functional moieties. At the final stage, the major weight loss for both aerogels occurred. For ALGPEI-3, 71.93% of weight decrease took place from 308 to 450° C. Regarding the GTH-CTNPEI aerogel, 59.89% weight loss happened from 295 to 480° C. These weight losses were due to the further decomposition of the polymer networks, i.e., CTN, ALG and PEI and cross-linked polymer chains. Thus, it was concluded that the ALGPEI-3 aerogel could be thermally stable up to 420° C. while the GTH-CTNPEI aerogel is stable up to 480° C. At temperatures higher than these, both aerogels became carbonaceous residues.

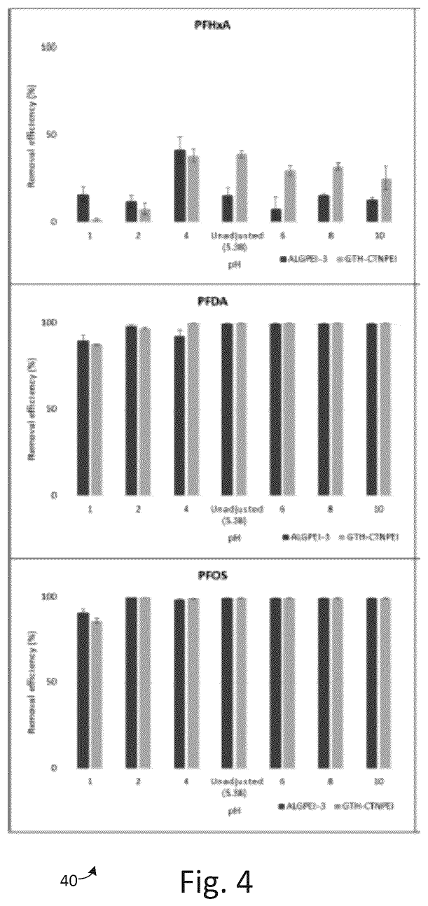

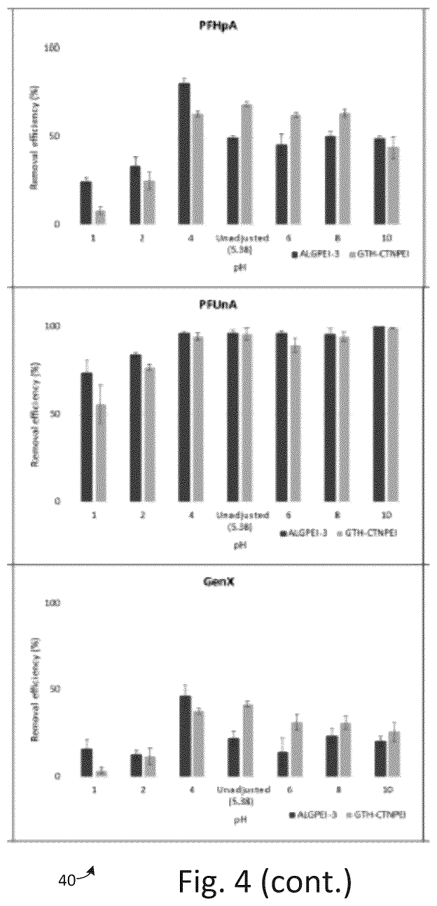

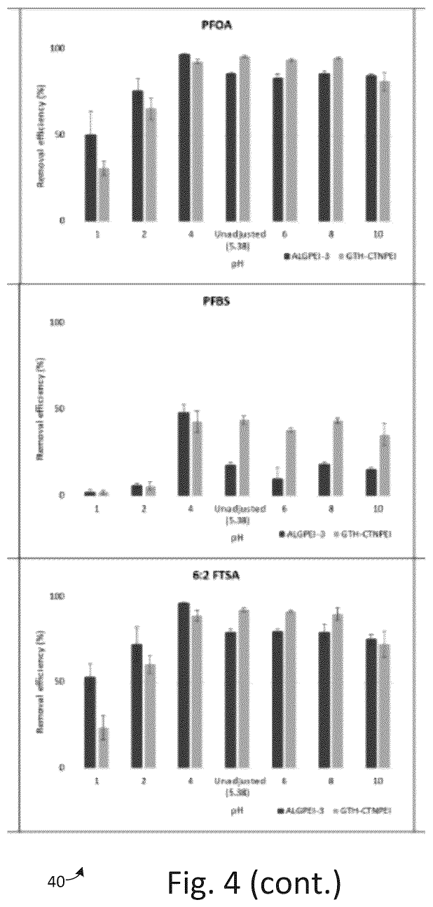

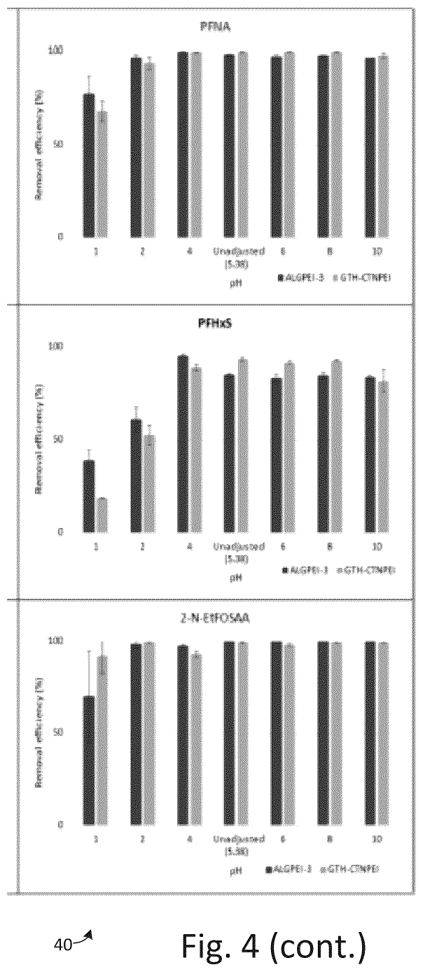

The pH of a given solution alters the surface properties of a sorbent, which leads to change of adsorption performance of the sorption material. At the same time, the solution pH also affects the chemistry of the adsorbates, in this case, PFASs. As shown in the graphs 40 of FIG. 4, in terms of ALGPEI, pH values between 2 and 10 had no observed effect on removal of relatively hydrophobic PFASs, such as PFNA, PFDA, PFOS and 2-N-EtFOSAA. For these four PFASs, a pH value of 1.0 led to decreased removal. Specific for PFUnA, pH values between 4 and 10 had no significant effect on the removal efficiency. However, much less sorption of this PFAS was observed at pH=1 and 2. Regarding relatively hydrophilic PFASs, for instance PFCAs (C6-C9), PFBS, PFHxS, GenX and 6:2 FTSA, pH at 4.0 appeared to result in the highest removal efficiencies. For GTH CTNPEI aerogels, the effect of pH on sorption of the five relatively hydrophobic PFASs was the same as that for ALGPEI-3. For relatively hydrophilic PFASs, the removal efficiencies at 296 pH between 4 and 8 did not have significant differences.

FIG. 4 is a series of graphs 40 of the removal efficacy of several biosorbents. The graphs illustrate the effect of pH on ALGPEI-3 and GTH-CTNPEI aerogels for PFASs adsorption. pH: 1, 2, 4, unadjusted (5.38), 6, 299 8 and 10; sorbent dose: 100 mg/L; initial PFASs concentration: 10 μg/L and time 1 h. Error bars represent the standard deviations of triplicate measurements. Some error bars are not visible due to their small sizes. A large number of PFASs has extremely low pKa. As a result, under a wide range of pH conditions, PFASs are negatively charged. At acidic pH 4, the functional groups (i.e., —NH₂, —OH) on the aerogel's surface would be protonated, leading to enhanced electrostatic attractions between the positively charged aerogel's surface and anionic PFASs compounds in the aqueous solution. Highly acidic conditions at pH=1 and 2, however, might result in electrostatic repulsion as both the aerogel and PFASs were highly protonated although the aerogels upheld their structural stability very well at these extremely acidic conditions.

A similar result has been previously observed, where the removal of PFOA, PFHxA and PFHpA at pH=2 was lower than that at pH=4. As pH increased to basic (pH>7) conditions, the deprotonation of —OH and —NH₂ groups would lead to electrostatic repulsion between the adsorbent's surface and anionic PFASs compounds. This repulsion would result in decreased removal efficiencies. Others have reported that the removal efficiency of PFOA by amino-functionalized graphene oxide (AGO) aerogel decreased from 99.9% to 89.4% with increasing pH from 1.60 to 9.26. This was assumed to be due to the formation of electronegative surface of the AGO aerogel and increased electrostatic repulsion between PFOA and the AGO aerogel at higher pH.

Here, however, both aerogels had broad pH tolerance regarding their adsorption performance. This was especially true for GTH-CTNPEI aerogel. This clearly indicated that hydrophobic interaction was the dominant mechanism underlying PFASs adsorption under a wide range of pH, overcoming the electrostatic repulsions between PFASs and negatively charged adsorbent's surfaces at high pH values. Three common isotherm models (i.e., Langmuir, Freundlich, Sips) were used to fit experimental adsorption data.

The Langmuir isotherm considers the dynamic equilibrium of adsorption and desorption on a monolayer solid surface. The Freundlich isotherm predicts adsorption processes occurring on heterogeneous (multilayer) surfaces, while the Sips model combines the Langmuir and Freundlich isotherms and covers adsorption in heterogeneous systems. As described above, both types of the aerogel had outstanding adsorption performance for long chain and relatively hydrophobic PFASs, and hence, the Cₑ value for individual PFASs at low initial concentrations were close to or lower than the limit of detection (LOD). To resolve this issue, the total qₑ and Cₑ values of all tested PFAS compounds instead of individual ones were used for these isotherm models.

For both ALGPEI-3 and GTH-CTNPEI aerogels, 337 the Freundlich model had an excellent fit in all range of PFAS concentrations. The calculated qₑ from the isotherm models were compared with the experimental qₑ. The relationship between the initial concentrations (C₀) and the mass of PFASs adsorbed by ALGPEI-3 and GTH-CTNPEI aerogels were obtained. Based upon the Sips isotherms, the maximum adsorption capacity of ALGPEI-3 and GTH-CTNPEI aerogels towards total PFASs removal was 3045 and 12133 mg/g, respectively, as shown in Table 1.

TABLE 1
Isotherm Parameter Values for Both Types of Aerogels.

| Isotherm | | Value | |
|---|---|---|---|
| model | Parameter | ALGPEI-3 | GTH-CTNPEI |
| Langmuir | R² | 0.99 | 0.98 |
| | K [symbol] (L/μg) | 1.0 × 10 [symbol] ⁴ | 5.24 × 10 [symbol] ⁵ |
| | [symbol] (mg/g) | 202 | 6232 |
| Freundlich | R² | 0.99 | 0.99 |
| | K [symbol] (mg L [symbol] /(g μg [symbol] )) | 0.05 | 0.03 |
| | m | 1.15 | 0.68 |
| Sips | R² | 0.99 | 0.96 |
| | K [symbol] (L/μg) | 3.65 × 10 [symbol] ⁵ | 5.83 × 10 [symbol] ⁵ |
| | qₘ (mg/g) | 3045 | 12133 |
| | n | 1.32 | 1.20 |

[symbol]

indicates data missing or illegible when filed

The ALGPEI-3 and GTH-CTNPEI aerogels exhibited much higher maximum adsorption capacity than those of reported biosorbents. Additionally, compared with those reported, our aerogels had at least four unique features: 1) in addition to PFOA and PFOS commonly studied at mg/L levels by other researchers, our two aerogels had superior sorption of a mixture of PFASs at the low end of μg/L levels that is environmentally relevant. Since PFASs often show up in contaminated environments as mixtures, the present aerogels hold high promise to remediate environments containing mixed PFASs at low concentrations; 2) theoretically, long chain PFASs, due to their stronger binding with a sorbent, outcompete short chains and lead to desorption of short chain PFAS over time. Here, although short chain PFASs were not 100% removed, the adsorption increased with time and desorption was not observed to occur at least within the tested duration of 24 h; 3) the adsorption of relatively hydrophobic PFASs appeared to be spontaneous. The short contact time will allow fast throughput and rapid treatment of PFASs contaminated water; and 4) the aerogels retaining their shape and structure integrity after PFASs sorption can be easily and completely separated from aqueous solutions. This eliminates the need of centrifugation or filtration for separating powdered sorbents from water.

The ALGPEI-3 and GTH-CTNPEI aerogels are advantageous because of their extremely high sorption capacities and unique features as being green, sustainable, independent of pH, and easily separable from aqueous solutions. The advantages of these aerogels for removing PFASs in environmental water matrices has at least four aspects, such as regenerability and reuse; final disposal of the spent sorbents; the aerogels' selectivity toward PFAS in real contaminated water; and the overall economic and environmental impacts. In addition, further surface modifications of CTN and ALG are needed to increase their affinity toward capturing short and ultrashort chain PFAAs; cationic, and zwitterionic PFASs.

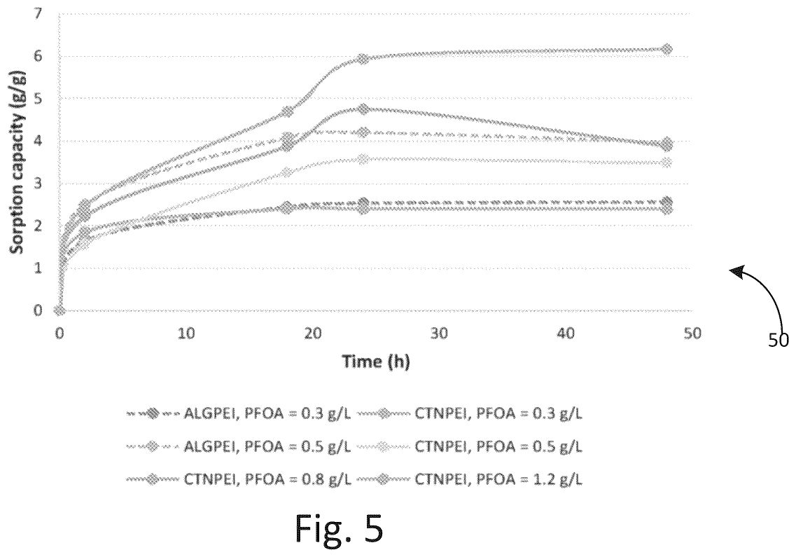

FIG. 5 is a graph 50 of sorption capacity changing with initial PFOA concentration and time. As shown in FIG. 5, using PFOA instead of PFAS mixtures, the experimental sorption capacity increased with time from O to 24 h and increased with increasing initial PFOA concentration. The ALGPEI sorbent had a sorption capacity of 4196 mg/g when added to PFOA solutions of 0.5 g/L. The CTN PEI sorbent sorbed 5929 mg PFOA/g when added to PFOA solutions of 1.2 g/L. If the initial PFOA concentration was higher than 1.2 g/L, it is expected that the sorption capacity will be higher given the trend of increasing sorption capacity with increasing initial PFAS concentrations. Thus, it is validated that ALGPEI and CTN PEI are able to sorb PFAS at least 3 and 6 times their own weight, respectively.

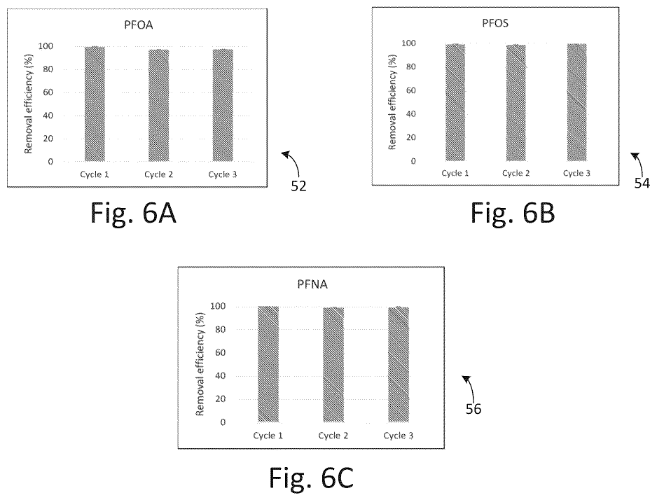

Second, the regenerability and reusability of the CTN PEI sorbent can be demonstrated. For this purpose, the spent sorbent was rinsed with basic methanol followed by water. Once dry, the sorbent was used to remove the same PFAS again. This process was repeated two more times. FIG. 6A is a graph 52 of removal efficiency of representative PFOA after three cycles of regeneration and reuse. FIG. 6B is a graph 54 of removal efficiency of representative PFOS after three cycles of regeneration and reuse. FIG. 6C is a graph 56 of removal efficiency of representative PFNA after three cycles of regeneration and reuse. As indicated by FIGS. 6A-6C, the removal efficiency of PFAS did not decrease significantly as the sorbent was reused.

Third, the removal of PFAS in tap water can be demonstrated in a real-world application. Here, initial PFAS concentrations were very low, to simulate real PFAS contaminated tap water. As demonstrated by FIG. 4, all long-chain PFAS were completely removed in one hour. Short-chain PFAS, such as PFBS, PFHxA, PFHpA and GenX needed longer time for maximum removal. But after 24 h, the removal efficiencies for these PFAS were all above 90% except GenX at an initial concentration of 100 ng/L.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A biosorbent, comprising:
biopolymer comprised of, at least, a polysaccharide; and
polyethyleneimine,
wherein the biopolymer and polyethyleneimine are cross-linked and formed into at least a semisolid at a concentration sufficient to substantially remove PFAS upon the semisolid being mixed in a PFAS-containing liquid.

2. The biosorbent of claim 1, wherein the biopolymer is comprised of one or more natural polysaccharides.

3. The biosorbent of claim 2, wherein the natural polysaccharides are one of an alginate, a chitosan, or both.

4. The biosorbent of claim 1, wherein the semisolid is comprised of fibers.

5. The biosorbent of claim 1, wherein the semisolid is comprised of an aerogel.

6. The biosorbent of claim 1, further including a cross-linker.

7. The biosorbent of claim 6, wherein the cross-linker is one of glutaraldehyde (GTH), epichlorohydrin (ECH) or both.

8. A method of making a biosorbent, comprising:
mixing a biopolymer comprised of, at least, a polysaccharide with polyethyleneimine such that the biopolymer and polyethyleneimine are cross-linked in a mixture; and
forming the mixture into, at least, a semisolid at a concentration sufficient to substantially remove PFAS upon the semisolid being mixed in a PFAS-containing liquid.

9. The method of claim 8, wherein mixing the biopolymer includes a mixing a biopolymer comprised of one or more natural polysaccharides.

10. The method of claim 9, wherein mixing the biopolymer includes a mixing a biopolymer comprised of one of an alginate, a chitosan, or both.

11. The method of claim 8, wherein forming the mixture into, at least, a semisolid is forming the mixture into fibers.

12. The method of claim 8, wherein forming the mixture into, at least, a semisolid is forming the mixture into an aerogel.

13. The method of claim 8, further mixing a cross-linker into the mixture of the biopolymer and polyethyleneimine.

14. The method of claim 13, wherein further mixing a cross-linker into the mixture of the biopolymer and polyethyleneimine is mixing one of glutaraldehyde (GTH), epichlorohydrin (ECH), or both, into the mixture.

15. A method of removing PFAS from a liquid with a biosorbent, comprising:
adding a semisolid biosorbent to a PFAS-containing liquid at a concentration sufficient to substantially remove PFAS from the PFAS-containing liquid, the semisolid biosorbent comprised of biopolymer linked with polyethyleneimine; and
removing the semisolid biosorbent from the PFAS-containing liquid after a predetermined duration.

16. The method of claim 15, wherein adding a semisolid biosorbent is adding a semisolid biosorbent containing biopolymer comprised of one or more natural polysaccharides.

17. The method of claim 15, wherein adding a semisolid biosorbent is adding a semisolid biosorbent comprised of fibers.

18. The method of claim 15, wherein adding a semisolid biosorbent is adding a semisolid biosorbent comprised of an aerogel.

19. The method of claim 15, wherein adding a semisolid biosorbent is adding a semisolid biosorbent further comprised of a cross-linker.

20. The method of claim 19, wherein adding a semisolid biosorbent is adding a semisolid biosorbent further including one of glutaraldehyde (GTH), epichlorohydrin (ECH), or both.
